(19) United States
(12) Patent Application Publication
(10) Pub. No.: US 2005/0226716 A1
(43) Pub. Date: Oct. 13, 2005

(54) Impeller for fuel pumps

(76) Inventors: Se-Dong Baek, Chungcheongnam-Do (KR); Jae-Seung Park, Daejeon-si (KR); Young-Hoon Kim, Daegu-si (KR); Sung-Uk Chang, Daejeon-si (KR)

Correspondence Address: Galgano & Burke, LLP, Suite 135, 300 Rabro Drive, Hauppauge, NY, 11788, US

(21) Appl. No.: 10/900,633

(22) Filed: Jul. 28, 2004

(30) Foreign Application Priority Data
Apr. 13, 2004 (KR) 10-2004-0025432

(51) Int. Cl. F03D 1/00

(52) U.S. Cl. 415/58.4

(57) ABSTRACT

An impeller for fuel pumps of automobiles, which maximizes the amount of fuel discharge of the fuel pumps by controlling the fuel inlet angle and the fuel outlet angle of the blades of the impeller, thus providing high operational pressures of the fuel pumps and improving operational performances of the fuel pumps, is disclosed. The impeller has a disc-shaped body, with a plurality of blades each having an inclined surface and provided around an outer edge of the disc-shaped body while being spaced out at regular intervals, and a plurality of impeller chambers defined between the blades while being vertically formed through the disc-shaped body to allow fuel to flow into and out of the chambers due to a high-speed rotating force of the impeller. The impeller further includes an inlet guide surface provided on each of the blades within a fuel inlet region of each of the impeller chambers, with a first angle defined between a vertical plane of the impeller and the inlet guide surface. The impeller further includes an outlet guide surface provided on each of the blades within a fuel outlet region of each of the impeller chambers, with a second angle defined between the vertical plane of the impeller and the outlet guide surface to be less than the first angle.

### BACKGROUND OF THE INVENTION

1. Field of the Invention

The present invention relates, in general, to impellers for fuel pumps and, more particularly, to an impeller for fuel pumps of automobiles which increases the fuel pumping force and the amount of fuel discharge of the fuel pumps by controlling the fuel guide angles of the blades of the impeller, thus providing high operational pressures of the fuel pumps.

2. Description of the Prior Art

Fuel pumps are devices that are provided in automobiles to effectively feed fuel from fuel tanks to injectors of engines.

As shown in FIG. 1, a conventional fuel pump for automobiles comprises a pump housing 200 which is fabricated with an upper casing 210 and a lower casing 220. An impeller 300 is installed in the pump housing 200 to rotate, while a drive motor 400 is coupled to the impeller 300 via a drive shaft which transmits a rotating force of the motor 400 to the impeller 300 to rotate the impeller 300 within the pump housing 200. The fuel pump further comprises a check valve 500 to controllably discharge the fuel from the fuel pump to an injector of an engine while the fuel is drawn into and discharged from the fuel pump by the centrifugal force of the rotating impeller 300.

The impeller 300 of the conventional fuel pump comprises a disc-shaped body as shown in FIG. 2. A plurality of radial blades 320 are provided around the outer edge of the impeller 300 while being spaced out at regular intervals, with a plurality of impeller chambers 340 defined between the blades 320 such that each of the impeller chambers 340 is vertically formed through the disc-shaped impeller 300.

In FIGS. 1 and 2 of the accompanying drawings, the reference numerals 230 and 240 respectively denote a fuel inlet and a fuel outlet of the pump housing 200 to introduce and discharge the fuel into and from the pump housing 200 during a rotation of the impeller 300.

The above-mentioned impeller 300 is operated as follows during an operation of the fuel pump. When the impeller 300 rotates by the rotating force of the drive motor 400, fuel is forcibly discharged outward from the fuel outlet region of each impeller chamber 340 in a radial direction. The fuel discharged from each impeller chamber 340 collides with an inner surface of a fuel path defined between the upper and lower casings 210 and 220 of the pump housing 200, thus being forced to flow into the fuel inlet region of an adjacent impeller chamber 340, so that the fuel sequentially circulates through the impeller chambers 340. In a brief description, the kinetic energy of the impeller 300 during a rotation of the impeller 300 is transmitted to the fuel, so that the pressurized fuel is pumped from a fuel tank to an injector of an engine.

In the meantime, the operational pressures of the fuel pumps of automobiles are typically determined according to engine capacities. In recent years, the fuel pumps of automobiles are required to provide high operational pressures. However, in the fuel pumps having the above-mentioned conventional impellers, an increase in the amount of fuel discharge from the fuel pumps during the high-pressure operations of the fuel pumps is limited. Thus, impellers for fuel pumps of automobiles capable of increasing the amount of the fuel discharge during the high-pressure operations of the fuel pumps have been actively studied in recent years.

### SUMMARY OF THE INVENTION

Accordingly, the present invention has been made keeping in mind the above problems occurring in the prior art, and an object of the present invention is to provide an impeller for fuel pumps of automobiles, in which the structure of blades that feed fuel from a fuel tank to an injector of an engine is changed to increase the fuel discharge of the fuel pump during a high-pressure operation of the fuel pump, thus improving operational performance of the fuel pump.

In order to achieve the above object, the present invention provides an impeller for fuel pumps, comprising a disc-shaped body, with a plurality of blades each having an inclined surface and provided around an outer edge of the disc-shaped body while being spaced out at regular intervals, and a plurality of impeller chambers defined between the blades while being vertically formed through the disc-shaped body to allow fuel to flow into and out of the chambers due to a high-speed rotating force of the impeller, further comprising: an inlet guide surface provided on each of the blades within a fuel inlet region of each of the impeller chambers, with a first angle defined between a vertical plane of the impeller and the inlet guide surface; and an outlet guide surface provided on each of the blades within a fuel outlet region of each of the impeller chambers, with a second angle defined between the vertical plane of the impeller and the outlet guide surface to be less than the first angle.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a sectional view illustrating the construction of a conventional fuel pump for automobiles;

FIG. 2 is a perspective view illustrating the construction and operation of an impeller installed in the conventional fuel pump of FIG. 1;

FIG. 3 is a partially broken perspective view of an impeller according to a preferred embodiment of the present invention, and an enlarged perspective view of a part of the impeller;

FIG. 4 is a sectional view illustrating the position and operation of the impeller of FIG. 3 when the impeller is installed in a fuel pump;

FIG. 5 is a side sectional view illustrating a flow of fuel relative to the impeller of FIG. 3 that is installed in the fuel pump;

FIGS. 6a and 6b are sectional views illustrating the flow of fuel around blades of the impeller of FIG. 3, in which:

FIG. 6a is a sectional view of a fuel inlet region of the impeller taken along the line A-A′ of FIG. 3; and

FIG. 6b is a sectional view of a fuel outlet region of the impeller taken along the line B-B′ of FIG. 3; and

FIG. 7 is a graph illustrating the operational pressure of a fuel pump as a function of the amount of fuel discharge according to a change in the fuel inlet and fuel outlet angles of the impeller of present invention.

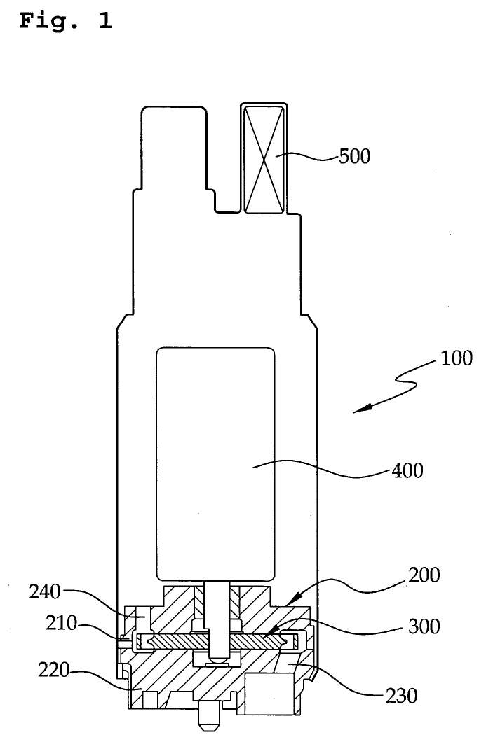

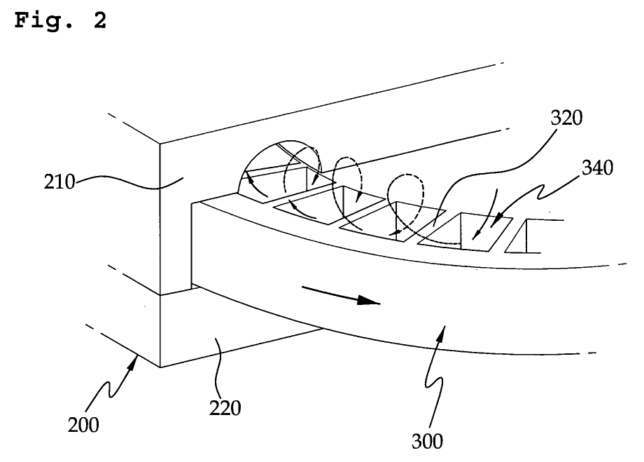

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

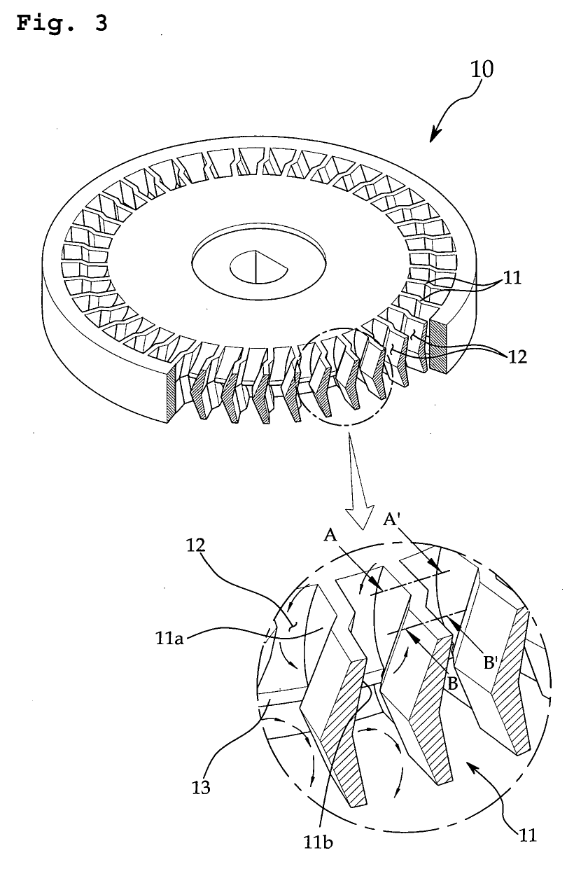

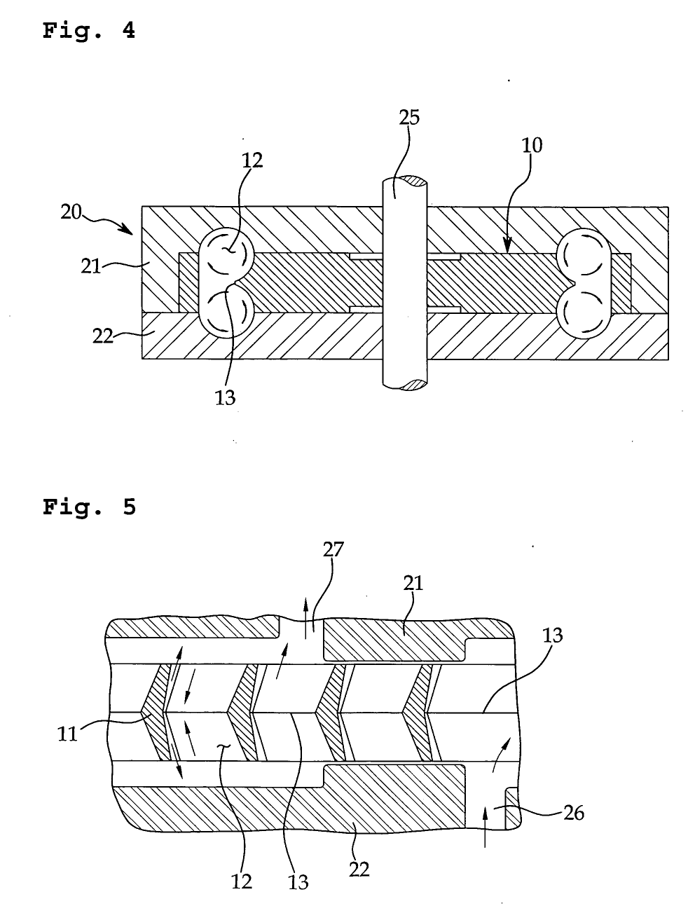

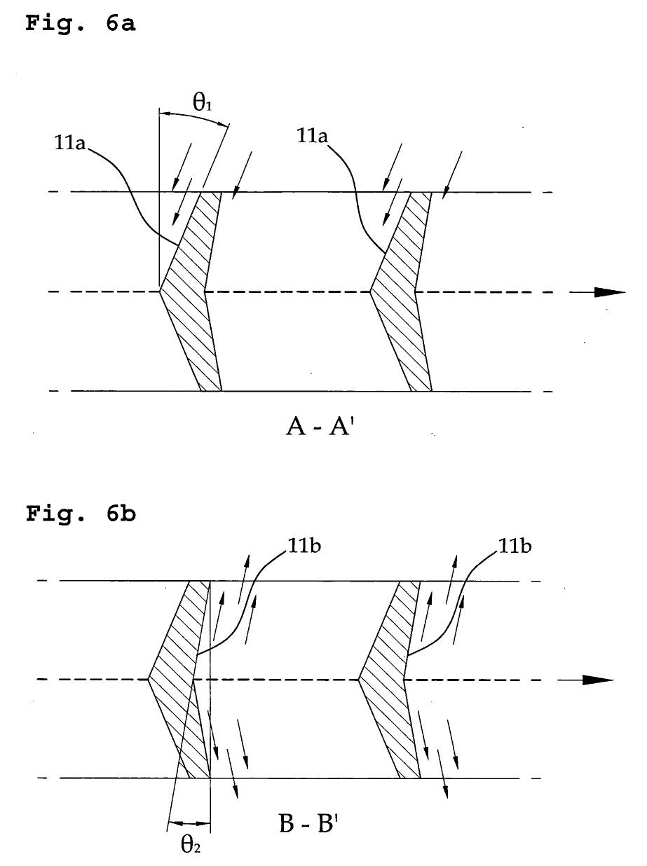

FIG. 3 is perspective views of an impeller according to the preferred embodiment of the present invention. FIG. 4 is a sectional view illustrating a fuel path defined in a pump housing when the impeller is installed in the fuel pump. FIGS. 6a and 6b are sectional views illustrating the flow of fuel around blades of the impeller.

First, the general construction of the impeller will be described herein below with reference to FIG. 3. As shown in the drawing, the impeller 10 comprises a plurality of blades 11 which are provided around the outer edge of the impeller 10 while being spaced out at regular intervals. Thus, a plurality of impeller chambers 12 are defined between the blades 11 such that each of the impeller chambers 12 is vertically formed through the impeller 10. A horizontal ridge 13 is formed on an inner circumferential surface of each of the impeller chambers 12 to divide each of the impeller chambers 12 into upper and lower sections. To allow for a smooth flowing of fuel into and out of the impeller chambers 12, each of the blades 11 is inclined on opposite side surfaces thereof to form a V-shaped cross-section, with upper and lower inclined surfaces respectively formed on upper and lower parts of each side surface of each blade 11 to be symmetrical with respect to the horizontal ridge 13.

As shown in FIG. 4 illustrating fuel currents within each of the impeller chambers 12, a fuel inlet region through which fuel flows into the chamber 12 is defined at an inside part of the chamber 12, while a fuel outlet region through which the fuel flows out of the chamber 12 is defined at an outside part of the chamber 12. In the present invention, the blades 11 of the impeller 10 are specifically designed such that a first angle θ1 between a vertical plane of the impeller 10 and an inlet guide surface 11a provided on each blade 11 around the fuel inlet region is different from a second angle θ2 between the vertical plane and an outlet guide surface 11b provided on each blade 11 around the fuel outlet region, as best seen in FIGS. 6a and 6b.

In other words, the first angle θ1 between the vertical plane and the inlet guide surface 11a to guide the inlet flow of the fuel in the inside part of each impeller chamber 12 is designed to be larger than the second angle θ2 between the vertical plane and the outlet guide surface 11b to guide the outlet flow of the fuel in the outside part of each impeller chamber 12. For example, when the first angle θ1 is set to 20˜45°, the second angle θ2 is determined to be less than the first angle θ1 by 1˜7°.

When the difference between the first angle θ1 and the second angle θ2 exceeds 70, the undesired effect of a pressure drop caused by a reduction in the rotating-directional speed component of the fuel offsets and exceeds the desired effect of pressure increase caused by the increased flow rate of the circulating fuel. In the above state, the operational efficiency of the fuel pump is inferior to the conventional fuel pumps.

In the drawings, the reference numeral 20 denotes a pump housing that is fabricated with an upper casing 21 and a lower casing 22.

The impeller, in which the inlet guide angle and the outlet guide angle of each blade are designed to be different from each other as described above, is operated as follows.

When the impeller 10 having the above-mentioned construction is installed between the upper and lower casings 21 and 22 of the pump housing 20, an annular fuel path is defined on a surface of each of the upper and lower casings 21 and 22 which faces the impeller chambers 12 as shown in FIG. 5.

When the impeller 10 installed in the pump housing 20 rotates at a high speed by the rotating force of the drive motor (not shown), which is transmitted to the impeller 10 via a rotating shaft 25. Thus, the fuel of a fuel tank (not shown) is drawn into the pump housing 20 through a fuel inlet 26. Within the pump housing 20, the fuel circulates through the fuel paths and the impeller chambers 12 while forcibly flowing in each of the chambers 12 in a direction perpendicular to a rotating direction of the impeller 10, prior to being discharged from the pump housing 20 through a fuel outlet 27.

In other words, when the impeller 10 rotates at a high speed, with the upper and lower surfaces of the impeller 10 being in close contact with the upper and lower casings 21 and 22, respectively, the fuel flows along the fuel paths while forcibly flowing within each impeller chamber 12 due to rotational friction caused by the blades 11 provided around the outer edge of the impeller 10. In the above state, the fuel is first guided by the horizontal ridge 13 within each chamber 12, and, thereafter, guided by the outlet guide surface 11b of a corresponding blade 11 to flow upward while defining a predetermined flowing angle. During a rotation of the impeller 10, the fuel continuously flows through the chambers 12 to flow upward from the chambers 12 due to the centrifugal force of the rotating impeller 10. The fuel discharged outward from the chambers 12 flows through the fuel paths provided on the upper and lower casings 21 and 22, and flows into the adjacent chambers 12 through the inlet guide surfaces 11a of the blades 11, until the fuel is discharged from the pump housing 20 through the fuel outlet 27. Thus, the fuel pump draws the fuel into the pump housing 20 and discharges the fuel from the pump housing 20 to an injector of an engine.

A better understanding of the present invention may be obtained through the following examples which are set forth to illustrate, but are not to be construed as the limit of the present invention.

The following examples were executed using similitude of fuel pumps having various impellers with different fuel guide angles by the Fluid Machinery Laboratory of Seoul National University of Korea to define the relation between the inlet guide angles within the fuel inlet regions and the outlet guide angles within the fuel outlet regions of the impellers.

### EXAMPLE 1

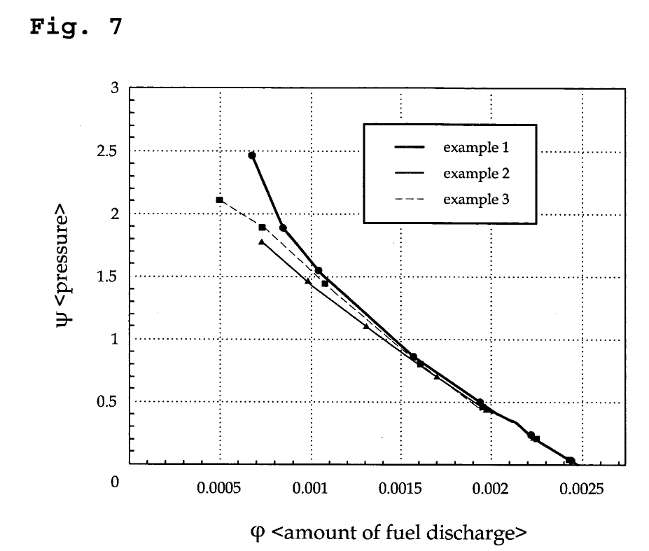

An impeller was prepared, of which blades 11 were designed such that the fuel inlet angle θ1 between a vertical plane of the impeller and an inlet guide surface 11a provided on each blade 11 around a fuel inlet region was set to 27°, and the fuel outlet angle θ2 between the vertical plane and an outlet guide surface 11b provided on each blade 11 around a fuel outlet region was set to 25°. A similitude of a fuel pump having the impeller was operated while sequentially changing the operational pressure, and a variation in the amount of fuel discharge was measured. The measuring results are given in Table 1 and a performance curve of the fuel pump is given in the graph of FIG. 7.

### EXAMPLE 2

An impeller was prepared, of which blades 11 were designed such that the fuel inlet angle θ1 between a vertical plane of the impeller and an inlet guide surface 11a provided on each blade 11 around a fuel inlet region was set to 32°, and the fuel outlet angle θ2 between the vertical plane and an outlet guide surface 11b provided on each blade 11 around a fuel outlet region was set to 38°. A similitude of a fuel pump having the impeller was operated while sequentially changing the operational pressure, and a variation in the amount of fuel discharge was measured. The measuring results are given in Table 1 and a performance curve of the fuel pump is given in the graph of FIG. 7.

### EXAMPLE 3

An impeller was prepared, of which blades 11 were designed such that the fuel inlet angle θ1 between a vertical plane of the impeller and an inlet guide surface 11a provided on each blade 11 around a fuel inlet region was set to 32°, and the fuel outlet angle θ2 between the vertical plane and an outlet guide surface 11b provided on each blade 11 around a fuel outlet region was set to 25°. A similitude of a fuel pump having the impeller was operated while sequentially changing the operational pressure, and a variation in the amount of fuel discharge was measured. The measuring results are given in Table 1 and a performance curve of the fuel pump is given in the graph of FIG. 7.

TABLE 1

| | | | Variation | |
|---|---|---|---|---|
| | | | in amount | Maximum |
| | Fuel inlet | Fuel outlet | of fuel | efficiency |
| Section | angle (θ1) | angle (θ2) | discharge | point |
| Example 1 | 27° | 25° | Increase by | Move to |
| | | | 5˜8% | high |
| | | | from | pressure |
| | | | reference | side |
| | | | discharge | |
| Example 2 | 32° | 38° | Reference | Reference |
| | | | discharge | |
| Example 3 | 32° | 25° | Increase by | Move to |
| | | | 2˜5% | high |
| | | | from | pressure |
| | | | reference | side |
| | | | discharge | |

From Table 1 and the graph of FIG. 7, it is noted that, in each of Examples 1 and 3 of the present invention, the maximum efficiency point is moved to a high-pressure side, and the amount of fuel discharge during a high-pressure operation of the fuel pump is further increased in comparison with the reference Example 2.

Therefore, when the impeller of the present invention with a fuel guide angle of an inlet guide region being different from a fuel guide angle of an outlet guide region is used in a fuel pump for automobiles, the fuel pump provides a higher operational performance at a high-pressure operation.

As apparent from the above description, the present invention provides an impeller for fuel pumps of automobiles which maximizes the amount of fuel discharge of the fuel pumps by controlling the fuel inlet angle and the fuel outlet angle of the blades of the impeller, thus providing high operational pressures of the fuel pumps and improving operational performances of the fuel pumps.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. An impeller for fuel pumps, comprising a disc-shaped body, with a plurality of blades each having an inclined surface and provided around an outer edge of the disc-shaped body while being spaced out at regular intervals, and a plurality of impeller chambers defined between the blades while being vertically formed through the disc-shaped body to allow fuel to flow into and out of the chambers due to a high-speed rotating force of the impeller, further comprising:
an inlet guide surface provided on each of the blades within a fuel inlet region of each of the impeller chambers, with a first angle defined between a vertical plane of the impeller and the inlet guide surface; and
an outlet guide surface provided on each of the blades within a fuel outlet region of each of the impeller chambers, with a second angle defined between the vertical plane of the impeller and the outlet guide surface to be less than the first angle.

2. The impeller for fuel pumps according to claim 1, wherein the first angle defined between the vertical plane of the impeller and the inlet guide surface is set to 20˜45°, and the second angle defined between the vertical plane of the impeller and the outlet guide surface is set to 13˜44°.

3. The impeller for fuel pumps according to claim 2, wherein the first angle defined between the vertical plane of the impeller and the inlet guide surface and the second angle defined between the vertical plane of the impeller and the outlet guide surface are determined such that a difference between the first angle and the second angle is 7° or less.

4. The impeller for fuel pumps according to claim 1, wherein the first angle defined between the vertical plane of the impeller and the inlet guide surface and the second angle defined between the vertical plane of the impeller and the outlet guide surface are determined such that a difference between the first angle and the second angle is 7° or less.
